(19) United States
(12) Patent Application Publication
(10) Pub. No.: US 2019/0147499 A1
(43) Pub. Date: May 16, 2019

(54) USER INTERFACE FOR AND PROCESSING OF ENTITY OF DIFFERENT ENTITY TYPES

(71) Applicant: Google Inc., Mountain View, CA (US)

(72) Inventors: Karen Yao, Mountain View, CA (US); Shu Niu, Mountain View, CA (US)

(73) Assignee: Google Inc., Mountain View, CA (US)

(21) Appl. No.: 14/080,448

(22) Filed: Nov. 14, 2013

Related U.S. Application Data
(60) Provisional application No. 61/792,806, filed on Mar. 15, 2013.

(51) Int. Cl. G06Q 30/02

(52) U.S. Cl. CPC G06Q 30/0276

(57) ABSTRACT

Methods, systems, and apparatus, including computer programs encoded on a computer storage medium, for managing a campaign entity of different entity types. In an aspect, a system facilitates a workflow that enables the on-demand updating of a campaign entity from a first format (e.g., a legacy format) that supports of first feature set to a second format (e.g., a new or updated format) that supports a second feature set.

### CLAIM OF PRIORITY

This application claims priority under 35 USC § 119(e) to U.S. Patent Application Ser. No. 61/792,806, filed on Mar. 15, 2013, the entire contents of which are hereby incorporated by reference.

### BACKGROUND

This specification relates on-line content item management.

The Internet enables access to a wide variety of content items, e.g., video and/or audio files, web pages for particular subjects, news articles, etc. Such access to these content items likewise enables opportunities for selective advertising. For example, advertisements can be provided with search results in response to a search query provided by a user; provided for web pages of third party online publishers that have content related to the advertisement; or provided in response to a specific request from a user, such as when a user requests information for particular products or services.

An advertising management system can be used to facilitate the value exchange between advertisers and publishers. Advertisers provide advertisements, specify selection criteria for ad campaigns, and offer bids for the opportunities to have their advertisements presented on publishers' webpages. Online advertisers use advertising management tools to manage their advertising campaigns. These management tools include an account interface that allows an advertiser to create and define various aspects of advertising campaigns and ad groups, such as keywords, selection criteria, budgets, bids for ad placement, duration, different types of advertisements, and so on. After the advertiser has specified the campaign and ad group data and activated the advertising campaigns and/or ad groups, advertisements can be dynamically selected and served on publishers' webpages according to the various keywords and other selection criteria specified by the advertiser.

Constructing an advertising campaign can be a time-consuming task, as advertisers often take great care in specifying features of their campaigns. Furthermore, the advertising management system that an advertiser uses may often provide new features and capabilities that an advertiser can use in new campaigns. Sometimes, however, the new features result in changes that are not backwards-compatible with existing campaigns.

### SUMMARY

In general, one innovative aspect of the subject matter described in this specification can be embodied in methods that include the actions of accessing content item management data that includes a plurality of campaign management entities including advertising campaign entities that each define an advertising campaign for distributing advertisements over a network, and for each advertising campaign entity, corresponding campaign entities for the advertising campaign defined by the advertising campaign entity; providing, to a user device, instructions that cause the user device to perform operations comprising: display a feature management user interface in which first campaign entities for an advertising campaign can be selected, wherein at least a first portion of the campaign entities used in the advertising campaign and stored in a first format are represented in the first format in the feature management user interface, the first portion of the campaign entities stored in the first format being used in the advertising campaign according to a first feature set; in response to receiving a selection of a proper subset of the first campaign entities, the proper subset being at least one of the first campaign entities of the first portion to be used in the advertising campaign according to a second feature set that is different from the first feature set, causing the user device to send a request for an update of only the selected first campaign entity and to display the selected first campaign entity in a second format that is different from the first format; in response to receiving the update request, generating, at the data processing apparatus, a new campaign entity and storing, in the content item management data, the new campaign entity in a second format that is different from the first format, wherein the second format enables the use of the new campaign entity according to the second feature set, and wherein the new campaign entity corresponds to the selected first campaign entity displayed in the second format. Other embodiments of this aspect include corresponding systems, apparatus, and computer programs, configured to perform the actions of the methods, encoded on computer storage devices.

In general, one innovative aspect of the subject matter described in this specification can be embodied in methods that include the actions of causing a user device to display a feature management user interface in which first campaign entities for an advertising campaign can be selected, wherein at least a first portion of the first campaign entities used in the advertising campaign and stored in a first format are represented in the first format in the feature management user interface, the first portion of the campaign entities stored in the first format being used in the advertising campaign according to a first feature set; and in response to receiving a selection of a proper subset of the first campaign entities, the proper subset being at least one of the first campaign entities of the first portion to be used in the advertising campaign according to a second feature set that is different from the first feature set, causing the user device to send a request to an advertisement management system for an update of only the selected first campaign entity and to display the selected first campaign entity in a second format that is different from the first format. Other embodiments of this aspect include corresponding systems, apparatus, and computer programs, configured to perform the actions of the methods, encoded on computer storage devices.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the actions.

Particular embodiments of the subject matter described in this specification can be implemented to realize one or more of the following advantages. The feature management user interface facilitates the on-demand conversion of campaign entities stored in a first format to a second format within a workflow in which the particular campaign entities being upgraded are ancillary to the overall workflow. In particular, the user is not required to update all of the campaign entities from the first format to the second format all at once, nor is the user required to suspend the workflow and initiate another separate workflow to update the campaign entities. This allows for piecemeal, just-in-time updates as needed. Accordingly, users can avail themselves of new features without invoking an update process separate from a workflow for the new feature, resulting in an intuitive and time-efficient user experience.

The details of one or more embodiments of the subject matter described in this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a block diagram of an example online advertising environment.

FIGS. 2-5 are illustrations of a feature management user interface during a workflow.

FIG. 6 is a flow diagram of an example process for managing, at an advertising system, a campaign entity for an updated feature set.

FIG. 7 is a flow diagram of an example process for managing, at a computer device, a campaign entity for an updated feature set.

FIG. 8 is a block diagram of a data processing apparatus system.

Like reference numbers and designations in the various drawings indicate like elements.

### DETAILED DESCRIPTION

Often when a new feature is introduced into a user-facing system, users are required to migrate existing data to a new data format that supports the new feature set. However, migration may not be backwards compatible, and other infrastructure mechanisms may not fully support the new features. For example, in the context of an advertising system, advertising campaigns are defined by campaign management entities, e.g., data objects and structures that include advertising campaign entities. Each advertising campaign entity defines an advertising campaign for distributing advertisements over a network, and each advertising campaign entity has corresponding campaign entities for the advertising campaign defined by the advertising campaign entity. Examples of such campaign entities include ad entities (or simply “ads”), bid entities (“bids”), selection criteria entities (“selection criteria”), extension entities e.g.

“sitelink extensions” “call extensions,” “app extensions,” and so on. Certain campaign entities that are used with a current feature set may be modified so as to support a new feature set. For example, in the case of sitelink extensions, which are multiple links to a site shown below a search result or advertisement that link to certain pages in addition to the landing page of the search result or the advertisement, a new feature set for sitelinks may provide flexibility in managing sitelinks, more detailed reporting than available for an existing feature set, and so on. However, an advertiser may not want to update all sitelink extensions when creating a new campaign that can use the updated extensions. This is because the advertiser may still want to use existing campaigns designed with the existing extensions, or may not want update hundreds or more extensions.

Accordingly, the advertisement management system provides a feature management user interface in which first campaign entities for an advertising campaign can be selected. A first portion of the campaign entities used in the advertising campaign and stored in a first format are represented in the first format in the feature management user interface. The first portion of the campaign entities stored in the first format is campaign entities that are used in the advertising campaign according to a first feature set. A user can select at least one of the first campaign entities of the first portion to be used in an advertising campaign according to a second feature set that is different from the first feature set. This second feature set, however, requires the upgrading of the selected campaign entity from the first format to a second format that is different from the first format. The selection causes the user device to send a request for an update of only the selected first campaign entity and to display the selected first campaign entity in a second format that is different from the first format. Thus, the user is visually notified of the update and the campaign entity is displayed in a way that distinguishes it from the other campaign entities stored in the first format.

These features and other features are described in more detail below.

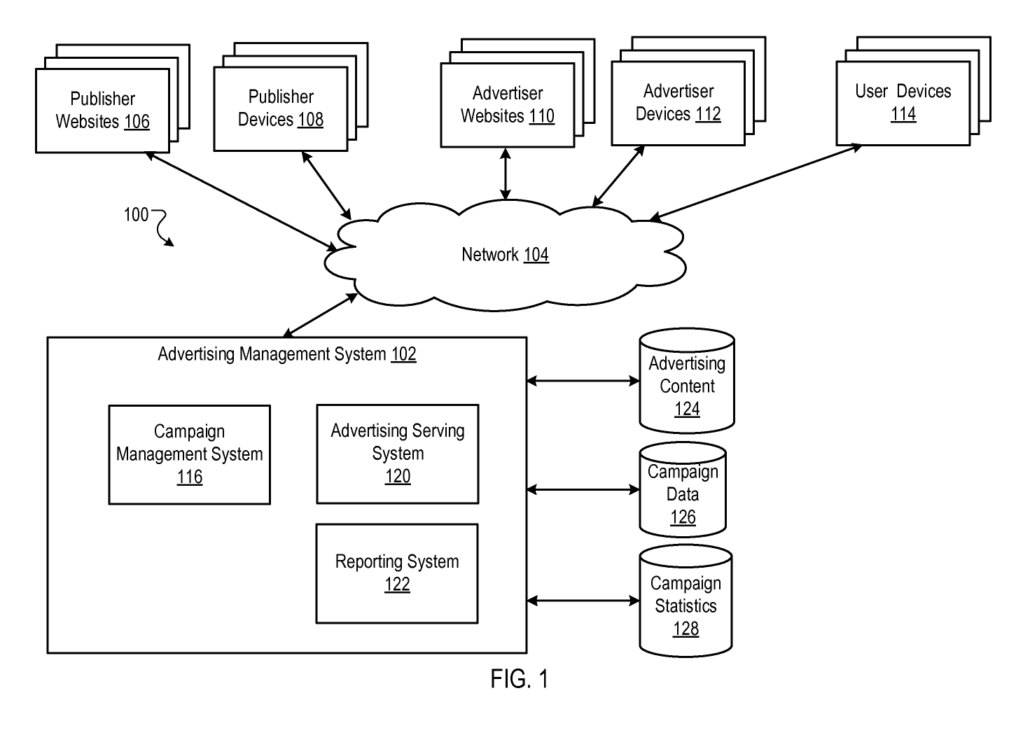

FIG. 1 is a block diagram of an example online advertising environment 100. The online advertising environment 100 utilizes an advertising management system 102 to facilitate the sale and purchase of online advertising opportunities between publishers and advertisers.

The online advertising environment 100 includes a computer network 104, such as a local area network (LAN), wide area network (WAN), the Internet, or a combination thereof, connecting publisher websites 106, publisher devices 108, advertiser websites 110, advertiser devices 112, user devices 114, and the advertising management system 102. The advertising management system 102 further has access to an advertising content store 124, a campaign data store 126, and a campaign statistics store 128.

Each publisher website 106 has one or more webpage resources associated with a domain name, and each publisher website 106 is hosted by one or more servers. An example website is a collection of webpages formatted in hypertext markup language (HTML) that can contain text, images, multimedia content, and programming elements.

Each publisher website 106 is maintained by a publisher, e.g., an entity that manages and/or owns the website.

Publisher devices 108, advertiser devices 112, and user devices 114 are electronic devices that are under the control of users. In particular, the publisher devices 108 are under control of users that are agents of the publishers, the advertiser devices 112 are under the control of users that are agents of the advertisers, and user devices 114 are under the control of users that are not associated with the publishers or advertisers. A device typically includes a user application, such as a web browser, to facilitate the sending and receiving of data over the network 104.

The advertising management system 102 facilitates the sale and purchase of advertising opportunities between publishers 106 and advertisers 110. The advertising management system 102 includes components such as a campaign management system 116, an advertising serving system 120, and a reporting system 122.

The campaign management system 116 provides user interfaces for advertisers (e.g., using advertiser devices 112) to define advertising campaigns and ad groups, submit advertising content, and specify various targeting and/or ad placement criteria for the advertising content in each advertising campaign and/or ad group. The advertising content is stored in the advertising content store 124 and the targeting and ad placement criteria are stored in the campaign data store 126. For each ad group or campaign, the advertisers can also specify bids for ad slots associated with particular keywords through the interface provided by the campaign management system 116. Advertisers' bids, budgets, as well as other campaign related preferences are also stored in the campaign data store 126.

An account management tool can be employed by an advertiser to create and manage a large number of online advertising campaigns for various products and services that the advertiser offers. The account management tool can be made available to the advertiser either through an online interface provided by the campaign management system 116 or as an account management software application installed and executed locally at the advertiser's devices 112. The online interface and/or the locally executed account management software application can be used for downloading existing account data from the campaign management system 116 and for uploading new and/or modified account data to the campaign management system 116.

The advertiser can create and manage multiple advertising campaigns using the account management tool offered by the campaign management system 116. The advertiser can further specify multiple ad groups under each ad campaign, and specify respective advertisements, budgets, keywords, and other selection and/or ad placement criteria for each of the ad groups. Typically, the advertising account can be abstracted into a hierarchical structure. For example, the advertising account can include one or more ad campaigns, each ad campaign can include one or more ad groups, and each ad group can include one or more advertisements and keywords.

Each advertising campaign is represented in the campaign data stores as a collection of associated campaign entities. Each particular advertising campaign is represented by an advertising campaign entity for the advertising campaign, and each advertising campaign entity can be associated with one or more advertisement group entities, each of which defines an advertisement group. Each advertising group entity, in turn, is associated with respective advertisement entities, a budget entity, ad selection entities, and bid entities. Each respective advertisement entity defines an advertisement, the budget entity defines a budget, each targeting entity defines a targeting criterion, and each bid entity defines a bid. Other entity associations are also possible, e.g., an advertising campaign entity can be associated with a budget entity defining an overall budget, etc.

To create a new ad campaign, a user can first specify values for the campaign level advertising parameters of the ad campaign. The campaign level advertising parameters include, for example, a campaign name, a preferred content network for placing ads, a budget for the ad campaign, start and end dates for the ad campaign, a schedule for ad placements, a targeted language, and targeted geographical locations. Other campaign level advertising parameters includes, for example, a payment scheme such as a cost-per-click (CPC), cost per thousand impressions (CPM), cost-per-action (CPA), and so on.

For the ad campaign, the user can further define one or more ad groups. An ad group contains one or more advertisements, which target a particular set of keywords, ad placements, or both. Ad groups under the same campaign can share the same campaign level advertising parameters, but have tailored specifications for particular ad group level advertising parameters, such as keywords, bids for keywords, budget, and so on.

After creating the campaign and one or more ad groups under the campaign, the advertiser can specify one or more keywords and advertisements to each ad group. The keywords are typically terms that are relevant to the product or services that the user wishes to promote for the ad group. Each keyword can include one or more terms. The advertiser can also specify whether exact match of keywords are required for ad placements on the content network.

In addition to keywords, for each ad group, the advertiser can also specify a number of advertisements for selection by the ad server when an advertising opportunity becomes available that matches the budget, ad schedule, maximum bids, keywords, and other selection criteria specified for the ad group. Different types of ads can be included in an ad group, such as a text ad, an image ad, a local business ad, a mobile ad, and so on.

Additional campaign entities can also be specified by the advertisers, such as ad extensions, etc. After the advertiser has specified all the required advertising parameters for each level and aspect of the ad campaign(s), the advertising campaign entity data (e.g., including the campaign structure and the advertising parameters on each level within the campaign structure) can be uploaded to the advertiser management system 116, and the data are persisted to the campaign data store 126. The advertising campaign can be created and activated according to the advertising campaign data specified by the advertiser.

The management system 116 also provides an interface for publishers (e.g., using publisher devices 108) to specify ad slots available on the publisher's online properties. For example, the publishers can specify the cost, type, dimensions, and targeting criteria (e.g., keywords associated with the content of the online properties) for each ad slot. The publisher management server 118 provides scripts or references to scripts to the publishers according to the specifications of the ad slots.

Each publisher 106 can insert instructions into its webpages or content items. When the webpages and content items are downloaded to user devices 114, the instructions are executed to generate one or more ad requests to the advertising management system 102. The advertising serving system 120 of the advertising management system 102 responds to the ad requests by sending advertisements to the requesting user device 114 for insertion into appropriate ad slots in the publisher's webpages or content items as rendered on the requesting user device 114. The advertisements can include embedded links to landing pages (e.g., webpages on the advertisers' websites 110) that a user is directed to when the user clicks on the advertisements presented on the publisher's webpages or in the content items.

The advertisements provided after a successful match, and optionally user responses (e.g., click-throughs, conversions, and so on) to the advertisements, can be tracked by various tracking mechanisms (e.g., tracking cookies, pixel callbacks, etc.), sent back to the advertising management system 102, and stored in the campaign statistics store 128. The tracking is enabled by various user opt-in processes. The reporting system 122 provides user interfaces for advertisers and publishers to review reports on the campaign statistics in various formats. Performance of particular keywords, ad groups, and campaigns can be measured based on various performance metrics, such as cost per action (e.g., click or conversion), conversion length (e.g., number of clicks between initial impression and conversion), and so on.

As described above, when a new feature is introduced into the advertising management system, advertisers may be required to migrate existing data to a new data format that supports the new feature set. However, migration may not be backwards compatible, and other infrastructure mechanisms may not fully support the new features. Furthermore, migrating all existing data that is eligible to be updated to the new format may be time consuming for an advertiser, and may also be unnecessary if the advertiser does not intend to use all the existing data in the context of the new feature.

Accordingly, in some implementations, the campaign management system 116 provides a workflow that facilitates the on-demand updating of a campaign entity from a first format (e.g., a legacy format) that supports of first feature set to a second format (e.g., a new or updated format) that supports a second feature set. The workflow is facilitated by feature management user interfaces that support the processing and management of campaign entities in both the first format and the second format.

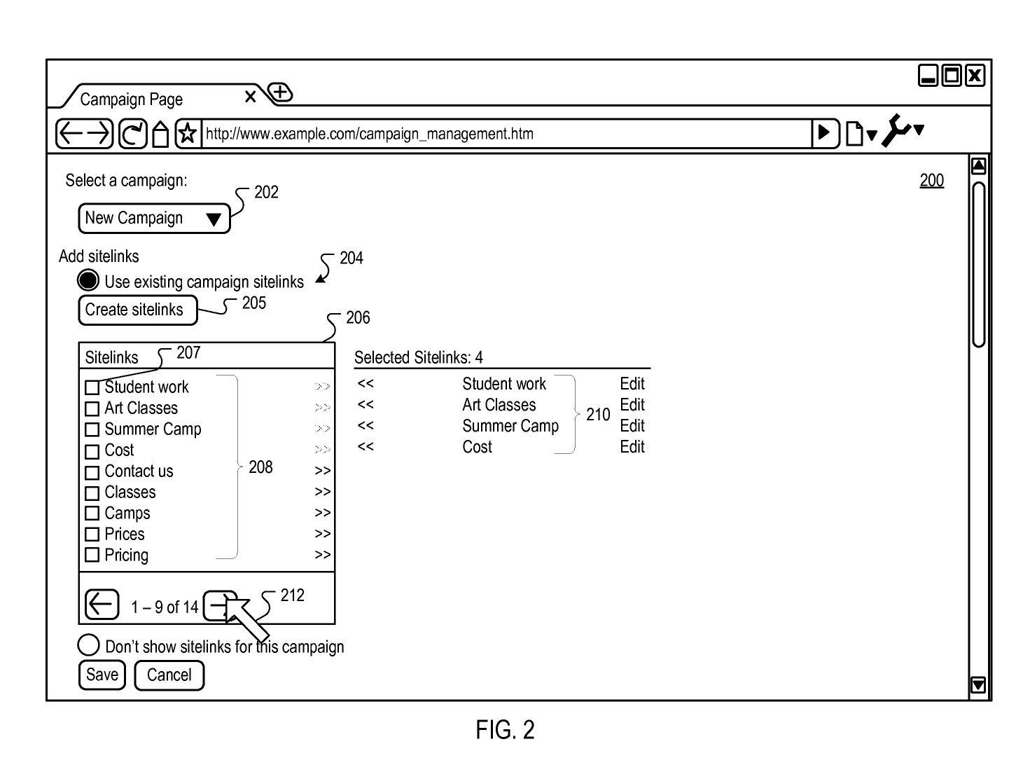

FIGS. 2-5 are illustrations of a feature management user interface 200 during a workflow. FIGS. 2-5 are described in the context of managing sitelink advertising extensions. However, the workflow and methods can be applied to any campaign entity.

The feature management user interface 200 is used to manage site link extensions for advertisements. The campaign management system 116 provides instructions to advertiser devices 112 (e.g., client computers) that cause the devices to render the user interface and perform the operations described below. The data that are displayed in the user interface 200 corresponds to content item management data, which includes campaign management entities such as advertising campaign entities that each defines an advertising campaign for distributing advertisements over a network. Each advertising campaign entity is associated with corresponding campaign entities for the advertising campaign (e.g., ad entities, bid entities, extension entities, etc.).

In the user interface 200, an advertiser may manage sitelinks for a new or existing campaign. For example, as shown in FIG. 2, the advertiser has decided to define sitelinks for a new campaign, as indicated by the selection drop down 202. However, the advertiser is using existing campaign sitelinks previously defied for other campaigns to add to the new campaign, as indicated by the radio button selection 204. Should the advertiser desire to create a brand new sitelink, the advertiser could select the “Create sitelinks” button 205, which would activate a new user interface (not shown) to create new sitelinks.

Sitelinks list 206 includes a portion of sitelinks 208 that the advertiser has previously defined and for which the advertiser can select for the new campaign. As shown in FIG. 2 and as indicated by the shaded arrows, the advertiser has selected four sitelinks 210 to include in the campaign.

The sitelinks list 206 indicates there are 14 sitelinks from which the advertiser may choose. A sitelink indicator 207 in the form of a white square is listed by each sitelink in the sitelink list. There are two possible formats for the sitelinks—a first format and a second format. The first format is a format in which the corresponding sitelinks are represented in the first format in the feature management user interface 200, and where the first format is used in the advertising campaign according to a first feature set. The second format is a format in which the corresponding sitelinks are represented in a second format in the feature management user interface 200, and where the second format is used in the advertising campaign according to a second feature set. For example, in FIG. 2, the sitelinks 208 are in the second format, as the indicator 207 is indicative of the second format. The second format may be, for example, an updated version of sitelink extension that supports additional or different features than are supported by sitelinks in a first format. Such additional features may be, for example, reporting data on an individual sitelink basis, and management of sitelinks on an individual basis.

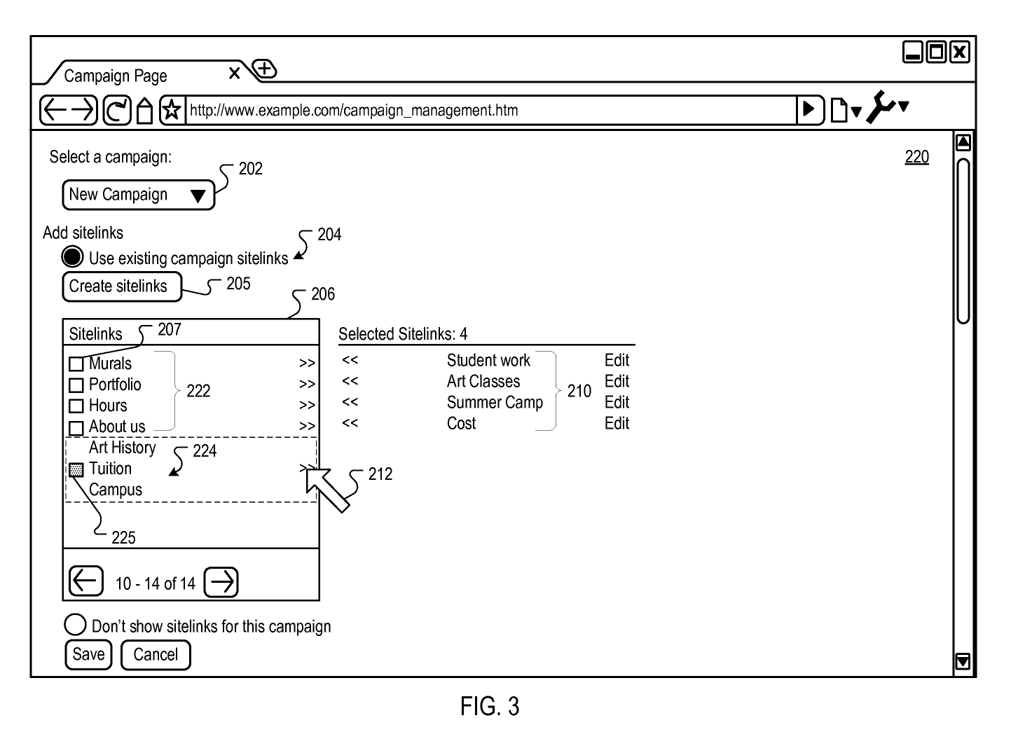

Using the cursor 212, the advertiser can select additional sitelinks. The resulting user interface 220 with the updated sitelink list is shown in FIG. 3. In FIG. 3, a first portion of the sitelinks 222 are shown in the first format, and a second portion 224 is shown in the second format, as indicated by the shaded sitelink indicator 225. The shaded sitelink indicator represents sitelinks stored in the first format.

The sitelinks 224 are grouped instead of listed individually. This is because, for example, sitelinks in the first format are grouped (as defined by the advertiser) and are used according to a first feature set that differs from the second feature set (e.g., served as a group, statistics are reported for the group and not for individual sitelinks, etc.).

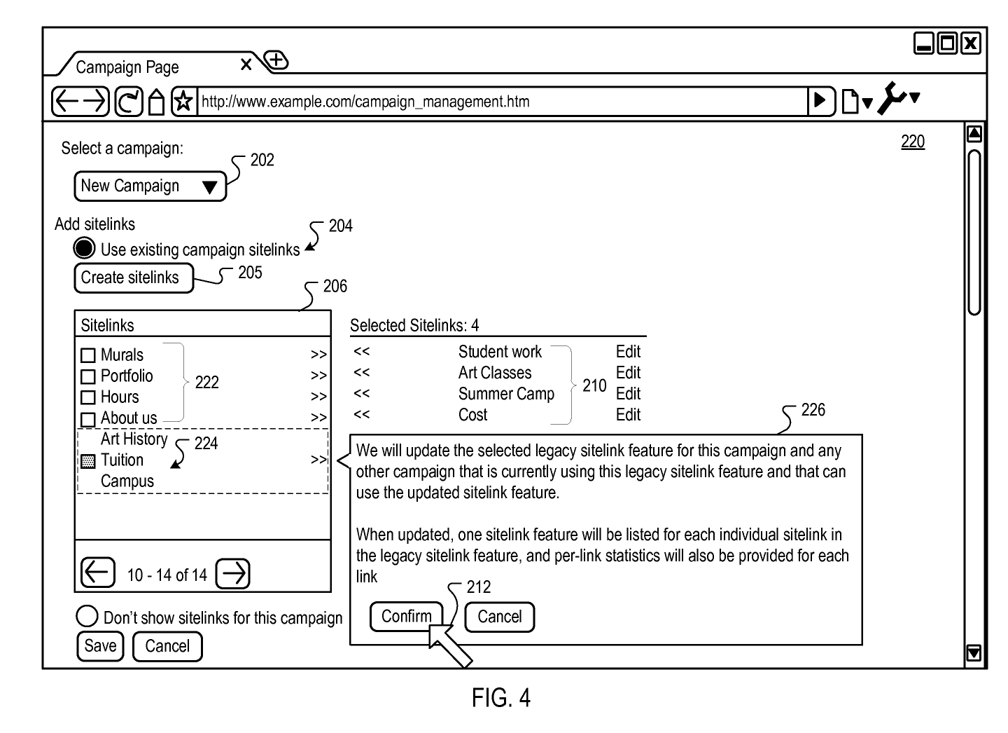

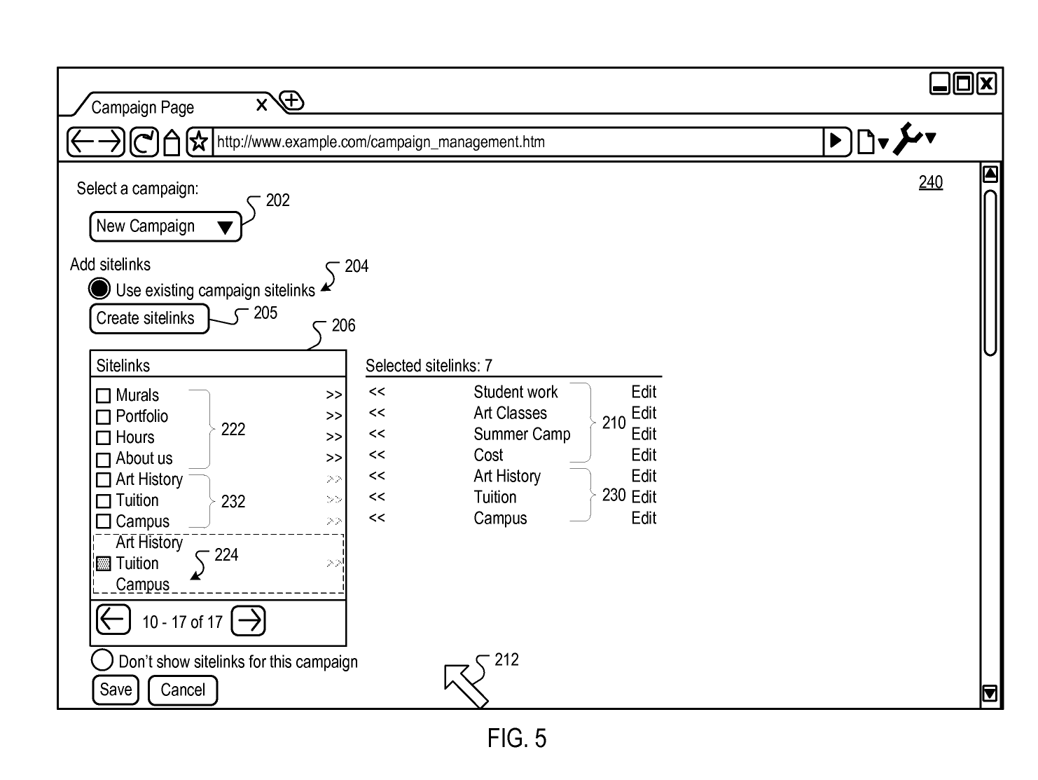

The advertiser has moved the cursor 212 to the sitelink 224 and will select the sitelinks to be used in the new campaign according to the second feature set. This will require, however, an update of the selected campaign entity (the sitelinks 224). Once the advertiser selects the sitelinks 224, the dialog box 226 of FIG. 4 is displayed. The dialog box 226 provides a message describing that the sitelinks 224 will be converted from the first format to the second format. Selection of the “confirm” command results in the user interface 240 of FIG. 5. New sitelinks 230 are now displayed in the selection list, and include sitelinks 230, which correspond to sitelinks 232 in the sitelink list 206. Note that the sitelinks 232 in the sitelink each have corresponding sitelink indicators 207 that indicate the sitelinks are stored in the second format. Additionally, sitelinks 224 are still listed and indicated as being in the first format.

The selection of the sitelinks 224 in FIG. 4 caused the user device to send a request for an update of only the selected first campaign entity and to display the selected first campaign entity in a second format in the user interface 240. In response to receiving the selection of first campaign entities 224 to be used in the advertising campaign according to the second feature set, the advertisement management system 110 creates new campaign entities and stores them in the second format that enables the use of the new campaign entities according to the second feature set. The new campaign entities 232 correspond to the selected first campaign entities of the sitelinks 224 displayed in the second format.

Accordingly, an advertiser need only select from existing campaign entities that have already been generated in the first format and request only those campaign entities be updated. This alleviates the need for the advertiser to essentially re-create similar campaign entities in a second format that are similar to the campaign entities of the first format. In other words, the advertiser can leverage off the existing campaign entities in the first format and use them to seed the creation of campaign entities in the second format, which saves time for the advertiser and eliminates the need to branch out of the workflow and engage in a more laborious process of creating and defining individual sitelinks. Furthermore, resource requirements for the advertisement management system 110 are reduced, as advertisers only update entities on an as-needed, just-in-time basis. As there may be millions of campaign entities that could be updated, the potential resource savings is significant.

In FIG. 5, the sitelinks 224 remain in the sitelinks list 206 and are displayed with the corresponding sitelinks 232. In some implementations, a campaign entity in the first format may continue to be displayed if it is still being used in an existing campaign. In variations of this implementation, once the sitelinks have been updated for the new campaign, the corresponding sitelinks 224 in the first format would no longer be displayed even though they are still being used by other campaigns, as sitelinks 232 have been created for the new campaign.

If, however, the campaign entity is not to be continued to be used according to the first feature set, then only the new campaign entity in the second format are displayed and maintained in the campaign data 126. For example, assume the sitelinks 224 had been previously defined by the advertiser for a previous advertising campaign that has been discontinued. In such a case, the sitelinks 224, once updated, would no longer be available in the first format, and thus would not be displayed.

Depending on the implementations used and the status of the campaign, the campaign management system 116 will send the corresponding data to the advertiser device so that the user interface 240 displays the proper representations of the campaign entities.

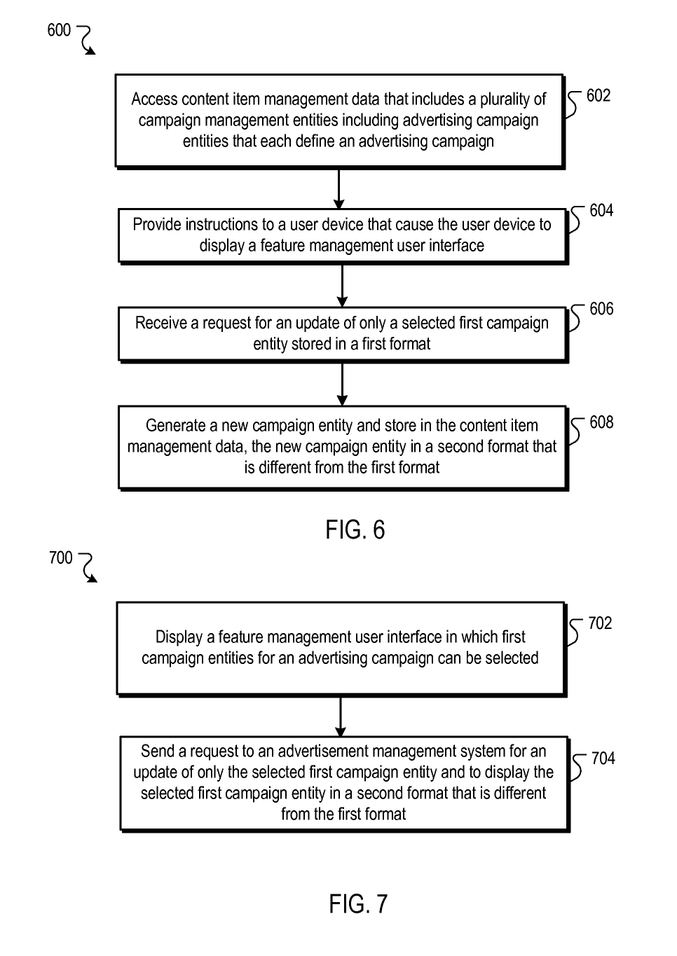

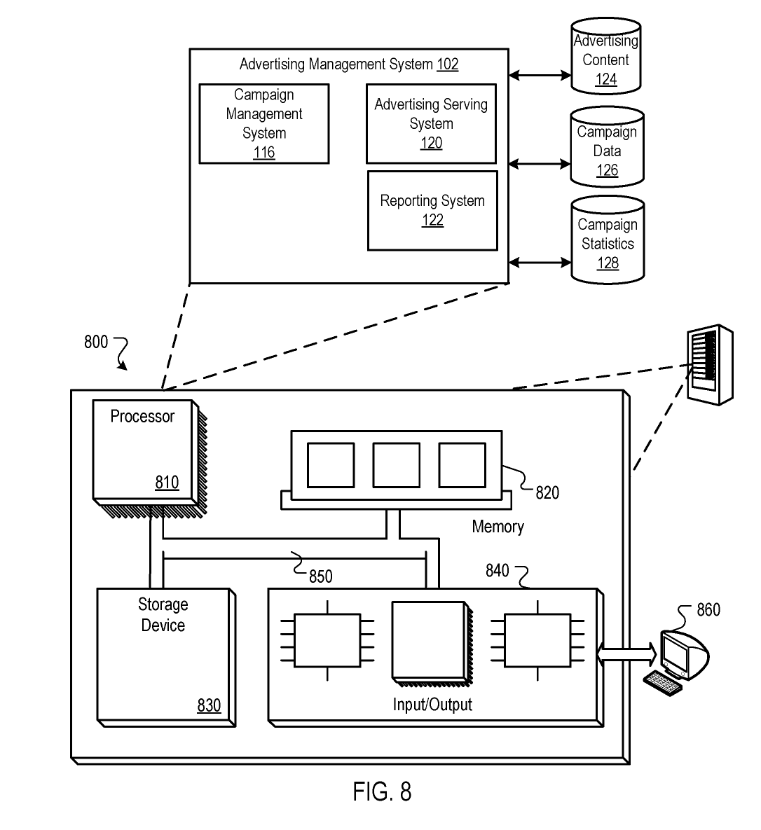

FIG. 6 is a flow diagram of an example process 600 for managing, at an advertising system, a campaign entity for an updated feature set. The process 600 can be implemented in a data processing apparatus of one or more computers in data communication.

The process 600 accesses content item management data that includes a plurality of campaign management entities, including advertising campaign entities that each defines an advertising campaign (602). For example, the campaign management system 116 accesses the campaign data 126 that includes advertising campaign entities that each define an advertising campaign for distributing advertisements over a network.

The process 600 provides instructions to a user device that cause the user device to display a feature management user interface (604). For example, the campaign management system 116 provides a webpage (or an application) to a user device that causes the user device to display a user interface that can be used to manage campaign entities, such as the user interfaces 200, 220 and 240 of FIGS. 2-5. The user interface can display first campaign entities for an advertising campaign, where at least a first portion of the campaign entities used in the advertising campaign and stored in a first format are represented in the first format in the feature management user interface. Additionally, the user interface can also simultaneously display second campaign entities for an advertising campaign to be used in the advertising campaign according to a second feature set that is different from the first feature set.

The process 600 receives a request for an update of only a selected first campaign entity stored in a first format (606). For example, in response to receiving a selection of a proper subset of the first campaign entities, where the proper subset is one of the first campaign entities of the first portion (e.g., the campaign entity 224 of FIG. 4), the user device sends a request for an update of only the selected first campaign entity. The campaign management system 116 receives the request.

The process 600 generates a new campaign entity and store in the content item management data, the new campaign entity in a second format that is different from the first format (608). For example, in response to receiving the update request, the advertising management system 110 generates a new campaign entity and stores the new campaign entity in the campaign data 126. The new campaign entities are stored in the second format and can be used according to the second feature set. As illustrated in FIG. 5, the new campaign entity (e.g., entities 232) corresponds to the selected first campaign entity displayed in the second format (e.g., entity 224).

FIG. 7 is a flow diagram of an example process 700 for managing, at a computer device, a campaign entity for an updated feature set. The process 700 can be implemented in, for example, a client computer used by an advertiser.

The process 700 displays a feature management user interface in which first campaign entities for an advertising campaign can be selected (702). For example, as shown in FIG. 3, at least a first portion of the first campaign entities (entity 224) used in the advertising campaign and stored in a first format are represented in the first format in the feature management user interface.

The process 700 sends a request to an advertisement management system for an update of only the selected first campaign entity and to display the selected first campaign entity in a second format that is different from the first format (704). For example, in response to a selection of the confirm command in FIG. 4, the user device sends a request to an advertisement management system for an update of only the selected first campaign entity and displays the selected first campaign entity in a second format (entities 232 of FIG. 5) that is different from the first format (entities 224 of FIG. 5).

The description, flows and illustrations described above are example implementations of processing and managing a campaign entity of different entity types (e.g., a type stored in a first format and used according to a first feature set and a type stored in a second format and used in a second feature set). Although an example is described in the content of advertisement extensions, and in particular sitelinks, any campaign entity of different types can be similarly processed and managed in accordance with the features described in this written description. Thus, the features are not limited to the particular example contexts described above.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

An example of computing system in which the above-described techniques can be implemented is shown in FIG. 14, which shows a block diagram of a data processing apparatus system. The system 800 can be utilized to implement the systems and methods described herein. The architecture of the system 800 can, for example, be used to implement a computer client, a computer server, or some other computer device.

The system 800 includes a processor 810, a memory 820, a storage device 830, and an input/output device 840. Each of the components 810, 820, 830, and 840 can, for example, be interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can, for example, include a hard disk device, an optical disk device, or some other large capacity storage device.

The input/output device 840 provides input/output operations for the system 800. In one implementation, the input/output device 840 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 860.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system, comprising:
a data processing apparatus including one or more computers;
a computer storage system storing instructions that when executed by data processing apparatus cause the data processing apparatus to perform actions comprising:
accessing, through a content item management system, content item management data that includes a plurality of sitelink extensions that are each used by multiple different content item campaigns for distributing content items over a network; providing, to a user device, instructions that cause the user device to perform operations comprising:
displaying a feature management user interface in which a set of sitelink extensions that are available for use in a particular content item campaign are displayed in a first visualization format and are selectable within the feature management user interface, wherein at least a first portion of the set of sitelink extensions available for use in the particular content item campaign are stored in a first data format that supports a particular set of features that each provide a particular content item management or visualization functionality, and are represented in the first data format in the feature management user interface, wherein the first portion of the set of sitelink extensions stored in the first data format are being used in a different content item campaign according to a first feature set that is supported by a first sitelink version; and
in response to receiving a selection of a proper subset of the set of sitelink extensions, the proper subset including a particular sitelink extension that is selected for use in the particular content item campaign according to a second feature set that (i) is different from the first feature set, (ii) requires the particular sitelink extension to be updated to a second data format that is not supported by the first sitelink version and is different from the first data format, and (iii) includes features that each provide a particular content item management or visualization functionality that is different from each of the features in the first data format, causing the user device to send a request for an update of only the proper subset of the set of sitelink extensions and to display the particular sitelink extension in a second visualization format that is different from the first visualization format; and
in response to receiving the update request updating only the proper subset of the set of sitelink extensions to the second data format while maintaining sitelink extensions from the set of sitelink extensions that are not included in the proper subset in the first data format, including updating the particular sitelink extension by performing operations including:
generating, at the data processing apparatus, a new version of the particular sitelink extension in the second data format, that is different from the first data format, for use in the particular content item campaign;
storing, in the content item management data, the new version of the particular sitelink extension that is used by the particular content item campaign; and
distributing content that includes the new version of the particular sitelink extension in the particular content item campaign according to the second feature set, while maintaining sitelink extensions that are not included in the proper subset in the first data format, and while the particular sitelink extension continues to be used in the first data format by the different content item campaign after updating the particular sitelink extension to the new version of the particular sitelink extension.

2. The system of claim 1, wherein the instructions cause the data processing apparatus to perform operations further comprising:
determining whether the particular sitelink extension is to be continued to be used according to the first feature set that is supported by the first sitelink version;
in response to determining that the particular sitelink extension is to be continued to be used according to the first feature set, maintaining the particular sitelink extension stored in the first format and the new version of the particular sitelink extension in the second format; and
in response to determining that the particular sitelink extension is not to be continued to be used according to the first feature set, maintaining, of the particular sitelink extension and the new version of the particular sitelink extension, only the new version of the particular sitelink extension in the second format.

3. The system of claim 2, wherein the instructions cause the data processing apparatus to perform operations further comprising:
in response to determining that the particular sitelink extension is to be continued to be used according to the first feature set, sending data to the user device that causes the feature management user interface to display both the particular sitelink extension represented in the first visualization format and display the new version of the particular sitelink extension represented in the second visualization format; and
in response to determining that the particular sitelink extension is not to be continued to be used according to the first feature set, sending data to the user device that causes the feature management user interface to display, of the particular sitelink extension and the new version of the particular sitelink extension, only the new version of the particular sitelink extension represented in the second visualization format.

4. The system of claim 1, wherein the set of sitelink extensions include sitelinks that are displayed with advertisements, and wherein updating the particular sitelink comprises enabling additional features that are not backwards compatible with the first format of the particular sitelink extension, wherein the additional features include one of reporting data on a per-sitelink basis or management of sitelinks on a per-sitelink basis.

5. The system of claim 1, further comprising a particular user device that receives the instructions that cause the user device to display the feature management user interface and send a request for an update of only the particular sitelink extension in response to receiving a selection of a proper subset of the set of sitelink extensions.

6-8. (canceled)

9. A computer implemented method, comprising:
accessing, through a content item management system, content item management data that includes a plurality of sitelink extensions that are each used by multiple different content item campaigns for distributing content items over a network;
providing, to a user device, instructions that cause the user device to perform operations comprising:
displaying a feature management user interface in which a set of sitelink extensions that are available for use in a particular content item campaign are displayed in a first visualization format and are selectable within the feature management user interface, wherein at least a first portion of the set of sitelink extensions available for use in the particular content item campaign are stored in a first data format that supports a particular set of features that each provide a particular content item management or visualization functionality, and are represented in the first data format in the feature management user interface, wherein the first portion of the set of sitelink extensions stored in the first data format are being used in a different content item campaign according to a first feature set that is supported by a first sitelink version; and
in response to receiving a selection of a proper subset of the set of sitelink extensions, the proper subset including a particular sitelink extension that is selected for use in the particular content item campaign according to a second feature set that (i) is different from the first feature set, (ii) requires the particular sitelink extension to be updated to a second data format that is not supported by the first sitelink version and is different from the first data format, and (iii) includes features that each provide a particular content item management or visualization functionality that is different from each of the features in the first data format, causing the user device to send a request for an update of only the proper subset of the set of sitelink extensions and to display the particular sitelink extension in a second visualization format that is different from the first visualization format; and
in response to receiving the update request updating only the proper subset of the set of sitelink extensions to the second data format while maintaining sitelink extensions from the set of sitelink extensions that are not included in the proper subset in the first data format, including updating the particular sitelink extension by performing operations including:
generating, at the data processing apparatus, a new version of the particular sitelink extension in the second data format, that is different from the first data format, for use in the particular content item campaign;
storing, in the content item management data, the new version of the particular sitelink extension that is used by the particular content item campaign; and
distributing content that includes the new version of the particular sitelink extension in the particular content item campaign according to the second feature set, while maintaining sitelink extensions that are not included in the proper subset in the first data format, and while the particular sitelink extension continues to be used in the first data format by the different content item campaign after updating the particular sitelink extension to the new version of the particular sitelink extension.

10. The computer implemented method of claim 9, further comprising:
determining whether the particular sitelink extension is to be continued to be used according to the first feature set;
in response to determining that the particular sitelink extension is to be continued to be used according to the first feature set, maintaining the particular sitelink extension stored in the first format and the new version of the particular sitelink extension in the second format; and
in response to determining that the particular sitelink extension is not to be continued to be used according to the first feature set, maintaining, of the particular sitelink extension and the new version of the particular sitelink extension, only the new version of the particular sitelink extension in the second format.

11. The computer implemented method of claim 10, further comprising:
in response to determining that the particular sitelink extension is to be continued to be used according to the first feature set, sending data to the user device that causes the feature management user interface to display both the particular sitelink extension represented in the first visualization format and display the new version of the particular sitelink extension represented in the second visualization format; and
in response to determining that the particular sitelink extension is not to be continued to be used according to the first feature set, sending data to the user device that causes the feature management user interface to display, of the particular sitelink extension and the new version of the particular sitelink extension, only the new version of the particular sitelink extension represented in the second visualization format.

12. The computer implemented method of claim 9, wherein set of sitelink extensions include sitelinks that are displayed with advertisements, and wherein updating the particular sitelink comprises enabling additional features that are not backwards compatible with the first format of the particular sitelink extension, wherein the additional features include one of reporting data on a per-sitelink basis or management of sitelinks on a per-sitelink basis.

13-18. (canceled)

19. A non-transitory computer storage system storing instructions that when executed by a data processing apparatus cause a data processing apparatus to perform operations comprising:
accessing, through a content item management system, content item management data that includes a plurality of sitelink extensions that are each used by multiple different content item campaigns for distributing content items over a network;
providing, to a user device, instructions that cause the user device to perform operations comprising:
displaying a feature management user interface in which a set of sitelink extensions that are available for use in a particular content item campaign are displayed in a first visualization format and are selectable within the feature management user interface, wherein at least a first portion of the set of sitelink extensions available for use in the particular content item campaign are stored in a first data format that supports a particular set of features that each provide a particular content item management or visualization functionality, and are represented in the first data format in the feature management user interface, wherein the first portion of the set of sitelink extensions stored in the first data format are being used in a different content item campaign according to a first feature set that is supported by a first sitelink version; and
in response to receiving a selection of a proper subset of the set of sitelink extensions, the proper subset including a particular sitelink extension that is selected for use in the particular content item campaign according to a second feature set that (i) is different from the first feature set, (ii) requires the particular sitelink extension to be updated to a second data format that is not supported by the first sitelink version and is different from the first data format, and (iii) includes features that each provide a particular content item management or visualization functionality that is different from each of the features in the first data format, causing the user device to send a request for an update of only the proper subset of the set of sitelink extensions and to display the particular sitelink extension in a second visualization format that is different from the first visualization format; and
in response to receiving the update request updating only the proper subset of the set of sitelink extensions to the second data format while maintaining sitelink extensions from the set of sitelink extensions that are not included in the proper subset in the first data format, including updating the particular sitelink extension by performing operations including:
generating, at the data processing apparatus, a new version of the particular sitelink extension in the second data format, that is different from the first data format, for use in the particular content item campaign;
storing, in the content item management data, the new version of the particular sitelink extension that is used by the particular content item campaign; and
distributing content that includes the new version of the particular sitelink extension in the particular content item campaign according to the second feature set, while maintaining sitelink extensions that are not included in the proper subset in the first data format, and while the particular sitelink extension continues to be used in the first data format by the different content item campaign after updating the particular sitelink extension to the new version of the particular sitelink extension.

20. The non-transitory computer storage system of claim 19, wherein the instructions cause the data processing apparatus to perform operations further comprising:
in response to determining that the particular sitelink extension is to be continued to be used according to the first feature set, sending data to the user device that causes the feature management user interface to display both the particular sitelink extension represented in the first visualization format and display the new version of the particular sitelink extension represented in the second visualization format; and
in response to determining that the particular sitelink extension is not to be continued to be used according to the first feature set, sending data to the user device that causes the feature management user interface to display, of the particular sitelink extension and the new version of the particular sitelink extension, only the new version of the particular sitelink extension represented in the second visualization format.

21. The non-transitory computer storage system of claim 19, wherein the set of sitelink extensions include sitelinks that are displayed with advertisements.

22. The non-transitory computer storage system of claim 19, wherein updating the particular sitelink comprises enabling additional features that are not backwards compatible with the first format of the particular sitelink extension.

23. The non-transitory computer storage system of claim 22, wherein the additional features include one of reporting data on a per-sitelink basis or management of sitelinks on a per-sitelink basis.
